(19) United States
(12) Patent Application Publication
(10) Pub. No.: US 2010/0075017 A1
(43) Pub. Date: Mar. 25, 2010

(54) SALTY TASTE ENHANCER, FOOD OR DRINK AND METHOD FOR PRODUCING FOOD OR DRINK

(76) Inventors: Toshihide Nishimura, Tokyo (JP); Mio Sakimori, Hiroshima (JP); Yoshinao Harada, Hiroshima (JP)

Correspondence Address: HARNESS, DICKEY & PIERCE, P.L.C., P.O. BOX 8910, RESTON, VA, 20195, US

(21) Appl. No.: 12/450,468

(22) PCT Filed: Mar. 28, 2008
(86) PCT No.: PCT/JP2008/056110

§ 371 Date: Oct. 30, 2009

(30) Foreign Application Priority Data
Mar. 30, 2007 (JP) 2007-094275

(51) Int. Cl. A23L 1/237

(52) U.S. Cl. 426/649

(57) ABSTRACT

An embodiment of the present invention relates to a salty taste enhancer containing an amino acid and/or a derivative thereof, the amino acid being L-leucine, or L-leucine and L-isoleucine. At least one embodiment provides: (i) a salty taste enhancer which is capable of effectively enhancing a salty taste of food or drink, (ii) food or drink containing the salty taste enhancer, and/or (iii) a method for producing the food or drink.

### TECHNICAL FIELD

The present invention relates to: (i) a salty taste enhancer for enhancing a salty taste of food or drink (hereinafter, may be generically referred to as “food”) without spoiling a taste of the food, (ii) food containing the salty taste enhancer, and (iii) a method for producing the food.

### BACKGROUND ART

Prevention of a lifestyle-related illness is an important task for a future aging society in Japan. Prevention of high blood pressure, which is one of the lifestyle-related illnesses, is particularly important since this illness may cause cerebral infarction or arteriosclerosis. It is known that an excessive intake of sodium chloride (salt) increases an incidence of high blood pressure. Therefore, in order to prevent the incidence, reduction in an intake of sodium chloride itself is generally carried out (e.g., an intake of low-salt food (i.e., low-salt food or drink) in which sodium chloride content is reduced).

However, there is a problem that low-salt food, whose taste is dull due to its less salty taste, is not tasty severely. This causes a problem that a good taste of food is spoiled. Therefore, in order to provide low-salt food whose taste is not spoiled, various measures have been taken. One of the measures is to use in a low-salt food a salt alternative whose taste is closer to a taste of sodium chloride. Accordingly, a variety of salt alternatives have been developed.

Salts such as potassium chloride (KCl) and ammonium chloride (NH₄Cl) have been known as such salt alternatives (Non Patent Literature 1).

Furthermore, as a liquid seasoning which keeps a salty taste while reducing a sodium chloride content, a liquid seasoning has been known in which the sodium chloride content is set to not more than 9% by mass and a potassium content, nitrogen content, and contents of a specific amino acid and a specific taste improvement ingredient are specified.

### Citation List

Non Patent Literature 1

Toru Fushiki, “Taste of Food (Shokuhin no Aji)”, published by Korin Publishing Co., Ltd. on Sep. 30, 2003, pp. 46-50

Patent Literature 1

Japanese Patent Application Publication, Tokukai, No. 2006-166750 A

### SUMMARY OF INVENTION

However, salts such as potassium chloride (KCl) and ammonium chloride (NH₄Cl) are not so much used as salt alternatives at present. This is because there is a problem that such salts provide different kinds of saltiness, compared with sodium chloride. Therefore, useful salt alternatives have not been developed yet, and it is therefore impossible to provide low-salt food which tastes adequately salty.

Moreover, Patent Literature 1 discloses that a liquid seasoning containing a given amount of an acidic amino acid and/or a basic amino acid gives a salty taste. Further, Description of Embodiments of the patent literature discloses that the use of sodium aspartate and monosodium glutaminate realizes an appropriate salty taste of low-salt soy sauce. However, it has not been made clear whether or not other amino acids are capable of enhancing a salty taste.

The present invention has been made in view of the conventional problems, and an object thereof is to provide: (i) a salty taste enhancer which is capable of causing food (i.e., food or drink) to taste adequately salty, (ii) food (i.e., food or drink) containing the salty taste enhancer, and (iii) a method for producing the food (i.e., food or drink).

In order to solve the problems, inventors of the present invention diligently continued research, and finally accomplished the present invention by finding that L-leucine and/or L-isoleucine and a derivative thereof are capable of enhancing a salty taste of food.

Namely, a salty taste enhancer according to the present invention contains an amino acid and/or a derivative thereof, the amino acid being L-leucine and/or L-isoleucine. According to the invention, it is possible to effectively enhance a salty taste of food by causing the food to contain the salty taste enhancer according to the present invention, which contains the foregoing chemical compound(s).

Furthermore, the salty taste enhancer according to the present invention allows an enhancement of a salty taste of the food, and it is therefore possible to cause the food to taste adequately salty even if a salt content of the food is reduced. Namely, the salty taste enhancer according to the present invention allows a reduction in a salt content of the food while keeping the food adequately salty. An increased intake of sodium chloride increases the risk of a lifestyle-related illness such as high blood pressure. Therefore, even a small reduction in the intake is highly effective for health maintenance. Accordingly, it is possible to utilize the salty taste enhancer according to the present invention for health maintenance such as the prevention of a lifestyle-related illness.

Moreover, the foregoing leucine and isoleucine are branched-chain amino acids which have functions such as a performance-enhancing function, and are actually used for supplements and beverages. Therefore, it is possible to provide, by use of the amino acid, a salty taste enhancer which is harmless to human.

Further, it is preferable that the salty taste enhancer according to the present invention further contain potassium chloride. This allows the amino acid and/or the derivative thereof and potassium chloride to bring about a synergistic salty taste enhancing effect, and it is therefore possible to further enhance a salty taste of the food. Hence, it is possible to cause the food to taste adequately salty even if a salt content of the food is further reduced. Accordingly, by causing the salty taste enhancer to contain potassium chloride, it is possible to provide low-salt food which is by no means inferior in salty taste to food in which salt content is not reduced.

It is also preferable that the salty taste enhancer according to the present invention further contain monosodium glutaminate. This allows the amino acid and/or the derivative thereof, potassium chloride, and monosodium glutaminate to bring about a synergistic salty taste enhancing effect, and it is therefore possible to further enhance a salty taste of food. Hence, it is possible to cause food to taste adequately salty in this case while reducing more salt in the food than in the case where only potassium chloride is added to the amino acid and/or the derivative thereof.

It is also preferable that food according to the present invention contain: a salty taste enhancer as mentioned above; and sodium chloride. This makes it possible to provide the food (i.e., food or drink) whose salty taste is enhanced. Furthermore, it is possible to provide low-salt food which is by no means inferior in salty taste to food in which salt is not reduced. Therefore, the food according to the present invention is highly suitable for those who eat conventional low-salt food whose salty taste is inadequate.

An increased intake of sodium chloride increases the risk of a lifestyle-related illness such as high blood pressure. Therefore, an intake of low-salt food according to the present invention allows (i) the prevention of the lifestyle-related illness and (ii) health maintenance.

Furthermore, a method for producing food according to the present invention, includes the step of causing the food to contain a salty taste enhancer containing an amino acid and/or a derivative thereof, the amino acid being L-leucine and/or L-isoleucine. According to the invention, it is possible to produce food (i.e., food or drink) whose salty taste is enhanced. This is because the method includes the step of causing the food to contain the salty taste enhancer. Namely, a salty taste of food produced in accordance with the method is enhanced, and it is therefore possible to reduce a salt amount of the food. This allows production of low-salt food which tastes adequately salty.

It is preferable that the method for producing food according to the present invention further include the step of causing the food to contain sodium chloride. For example, in a case where the sodium chloride content in the food is less than 0.2% by weight, it may be impossible to obtain a satisfactory salty taste enhancing effect even if the salty taste enhancer in accordance with the present invention is used. However, according to the arrangement, it is possible to cause even food in which the sodium chloride content is as small as 0.2% by weight to fully enjoy a salty taste enhancing effect of the salty taste enhancer in accordance with the present invention, thereby realizing food whose salty taste is enhanced. This is because the method includes the steps of (i) causing food to contain a salty taste enhancer and (ii) causing the food to contain sodium chloride.

It is also preferable that the method for producing food according to the present invention further include the step of causing the food to contain potassium chloride. This allows the amino acid and/or the derivative thereof and potassium chloride to bring about a synergistic salty taste enhancing effect, and it is therefore possible to further enhance a salty taste of the food. Hence, it is possible to cause the food to taste adequately salty even if a salt content of the food is further reduced. This allows production of lower-salt food.

It is also preferable that the method for producing food according to the present invention further include the step of causing the food to contain monosodium glutaminate. This makes it possible to attain food or drink in which the amino acid and/or the derivative thereof, potassium chloride, and monosodium glutaminate to bring about a synergistic salty taste enhancing effect. It is therefore possible to provide lower-salt food or drink whose salty taste is further enhanced, while reducing more salt in the food or drink.

For a fuller understanding of the nature and advantages of the invention, reference should be made to the ensuing detailed description taken in conjunction with the accompanying drawings.

### DESCRIPTION OF EMBODIMENTS

An embodiment according to the present invention is described below. However, the present invention is not limited to this.

Note, in the present specification, that a “salty taste enhancer” refers to a composition which is capable of enhancing a salty taste of food (i.e., food or drink) when contained in the food and that the “composition” refers to a mixture which contains a single compound or multiple compounds. Note also that the present specification refers to a result in which a salty taste of the food is enhanced by use of the salty taste enhancer as a “salty taste enhancing effect”.

“Enhancing a salty taste of food” as described earlier means that there is an improvement in at least one evaluation item out of: (i) strength, (ii) continuity, and (iii) fullness of a salty taste of the food. For example, Example 1 (described later) found the salty taste enhancing effect of L-leucine on a sodium chloride solution in accordance with an evaluation of (i) strength, (ii) continuity, and (iii) fullness of a salty taste. Further, Example 2 found the salty taste enhancing effect of L-leucine on a consommé soup in accordance with an evaluation of strength of a salty taste.

Note, in the present specification, that “food” generically refers to what human beings and animals eat or drink. In the present specification, note also that “low-salt food” refers to food or drink which is lower in content of sodium chloride than food or drink which tastes adequately salty and that “low-salt food which tastes adequately salty” refers to low-salt food or drink which is equivalent to or stronger than food or drink which tastes adequately salty in salty taste.

“Food which tastes adequately salty” as described earlier refers to food or drink which contains enough sodium chloride for the food or drink to taste good. Whether food tastes good or not depends on preferences of human beings or animals that take in the food or on how raw materials are blended in the food. Therefore, enough sodium chloride content for food to taste good is not particularly limited. It is possible to appropriately set a value of the content in accordance with preferences of human beings or animals that take in the food or how raw materials are blended in the food.

[1: Salty Taste Enhancer]

A salty taste enhancer according to the present invention contains an amino acid and/or a derivative thereof. Namely, the salty taste enhancer may contain only one kind of amino acid or derivative thereof. The salty taste enhancer may also contain more than one kind of amino acid or more than one kind of derivative of the amino acid. The salty taste enhancer may also contain more than one kind of amino acid and more than one kind of derivative of the amino acid. Specifically, it is possible to use L-leucine and/or L-isoleucine as the amino acid. Moreover, it is preferable to use L-leucine since it is the most effective in enhancing a salty taste.

Examples (described later) succeeds in enhancing a salty taste of food by 12% by weight or so at the maximum by use of the salty taste enhancer containing L-leucine. Namely, the salty taste enhancer containing L-leucine allows a reduction to 88% by weight or so in an amount of sodium chloride to use.

L-leucine and L-isoleucine are branched-chain amino acids which have functions such as a performance-enhancing function, and are actually used for supplements and beverages. Therefore, by use of these amino acids, it is possible to provide a salty taste enhancer which is harmless to human and highly efficient in enhancing a salty taste.

The amino acid may be a free amino acid or salt of the amino acid which salt is physiologically acceptable. Note here that the salt which is physiologically acceptable is not particularly limited, provided that the salt is harmless to human and is capable of enhancing a salty taste of food. The salt is exemplified by: alkali metal salt (e.g., potassium salt or the like), alkaline earth metal salt (e.g., calcium salt, magnesium salt, or the like), ammonium salt, organic basic salt (e.g., trimethylamine salt, triethylamine salt, pyridine salt, picoline salt, dicyclohexylamine salt, N, N′-dibenzylethylenediamine salt, or the like), organic acid salt (e.g., acetate, maleate, tartrate, methanesulfonate, benzenesulfonate, formate, toluenesulfonate, trifluoroacetate, or the like), and inorganic acid salt (e.g., hydrochloride, hydrobromide, sulfate, phosphate, or the like). However, the salt is not limited to these.

The free amino acid or the physiologically acceptable salt of the amino acid may be a natural product or a synthetic product. It is possible to obtain the natural product by, for example, decomposing natural protein with an enzyme or the like. However, how to obtain the natural product is not limited to this. On the other hand, it is possible to obtain the synthetic product, by, for example, carrying out a substitution reaction between halogenocarboxylic acid and ammonia. However, how to obtain the synthetic product is not limited to this. The “halogenocarboxylic acid” is a chemical compound in which halogen is substituted for a hydrogen atom of hydrocarbon radical of fatty acid, and is exemplified by fluoroacetic acid and chloroacetic acid. However, the halogenocarboxylic acid is not limited to these.

Note, in the present specification, that a “derivative of an amino acid” indicates an amino acid to which a chemical compound such as a functional group or sugar is bonded, a peptide, or a peptide to which a chemical compound such as a functional group or sugar is bonded. The functional group is exemplified by an alkyl group (e.g., a methyl group, an ethyl group, or the like), a nitro group, and a sulfo group. However, the functional group is not limited to these.

A method for bonding an alkyl group to an amino acid is not particularly limited. It is possible to introduce an alkyl group to a carbon atom, a nitrogen atom or an oxygen atom of an amino acid by, for example, carrying out alkylation by use of an alkyl halide group or the like. Furthermore, a method for bonding a nitro group to an amino acid is not particularly limited. It is possible to introduce a nitro group to a carbon atom, a nitrogen atom or an oxygen atom of an amino acid by, for example, carrying out nitration by use of a mixed acid of nitric acid and sulfuric acid. Moreover, a method for bonding a sulfo group to an amino acid is not particularly limited. It is possible to introduce a sulfo group to a carbon atom, a nitrogen atom or an oxygen atom of an amino acid by, for example, carrying out sulfonation by use of sulfuric acid or the like.

The sugar is exemplified by a monosaccharide (e.g., glucose, fructose, galactose, or the like), a disaccharide (e.g., maltose, lactose, sucrose, or the like), and a polysaccharide (e.g., starch, glycogen, cellulose, or the like). However, the sugar is not limited to these. A method for bonding such a sugar to an amino acid is not particularly limited. It is possible to employ a conventionally publicly-known method. It is possible to bond an aldehyde group at an end of the sugar to an amino group of the amino acid by, for example, carrying out reductive amination.

The peptide indicates a chemical compound in which not less than two amino acids are bonded by a peptide bond. As long as the peptide contains at least one amino acid selected from the group consisting of L-leucine and L-isoleucine, the peptide may contain any other amino acid. Any other amino acid as mentioned above may be of L-configuration or of D-configuration, and it is exemplified by an α-amino acid, a β-amino acid, and a γ-amino acid.

The α-amino acid is specifically exemplified by glycine, alanine, valine, leucine, isoleucine, serine, threonine, cysteine, methionine, tryptophan, tyrosine, proline, glutamine, glutamic acid, asparagine, aspartic acid, phenylalanine, lysine, arginine, and histidine. Furthermore, the β-amino acid is specifically exemplified by β-alanine. However, the β-amino acid is not limited to this. Moreover, the γ-amino acid is specifically exemplified by γ-aminobutyric acid (GABA) and carnitine. However, the γ-amino acid is not limited to these.

Note that the number of the amino acids contained in the peptide is not particularly limited, but preferably 2 to 500, more preferably 2 to 100, and still more preferably 2 to 30.

A method for producing the peptide is not particularly limited. It is possible to produce the peptide by, for example, condensing any other amino acid as mentioned above and L-leucine and/or L-isoleucine.

A peptide to which a functional group or sugar is bonded specifically indicates a peptide in which a functional group or sugar is bonded to an amino acid included in the peptide. Therefore, it is possible to employ a method for combining the functional group or sugar with the amino acid for a method for combining the functional group or sugar with a peptide.

The salty taste enhancer according to the present invention may further contain an additive of various types usable for food, such as an inorganic salt, an acid, a chemical seasoning, a saccharide, a condiment, a diluent, a coloring agent, and the like, in addition to an amino acid and/or a derivative thereof.

The inorganic salt is exemplified by potassium chloride and magnesium sulfate. However, the inorganic salt is not limited to these. It is possible to use such inorganic salts alone or in combination.

For the inorganic salt, it is possible to use potassium chloride, magnesium sulfate, or the like. However, it is particularly preferable to use potassium chloride. The use of potassium chloride allows the amino acid and/or the derivative thereof and potassium chloride to bring about a synergistic salty taste enhancing effect, and it is therefore possible to further enhance the salty taste of the food. Hence, it is possible to cause the food to taste adequately salty even if a salt content of the food is further reduced.

As described later in the Examples, the use of the amino acid and/or the derivative thereof and potassium chloride in combination allows an enhancement of a salty taste of food by 20% by weight or so at the maximum. Namely, the amount of sodium chloride to use can be reduced to 80% by weight or so.

The acid is exemplified by ascorbic acid, fumaric acid, malic acid, tartaric acid, citric acid, carboxylic acid such as fatty acid, and salts of the respective acids. However, the acid is not limited to these. The salt is exemplified by potassium salt. However, the salt is not limited to this. It is possible to use such acids alone or in combination.

The chemical seasoning is exemplified by monosodium glutaminate and a nucleic acid seasoning (e.g., sodium inosinate, sodium guanylate, or the like). However, the chemical seasoning is not limited to these. It is possible to use such chemical seasonings alone or in combination.

It is preferable to use monosodium glutaminate as the chemical seasoning. It is possible to cause the salty taste enhancer according to the present invention to be more effective by causing the salty taste enhancer containing L-leucine and/or L-isoleucine and potassium chloride to further contain monosodium glutaminate.

As described later in the Examples, the use of L-leucine, potassium chloride, and monosodium glutaminate in combination allows an enhancement of a salty taste of food by 30% by weight or so at the maximum. Namely, the amount of sodium chloride to use can be reduced to 70% by weight or so.

The saccharide is exemplified by sucrose, glucose, and lactose. However, the saccharide is not limited to these. It is possible to use such saccharides alone or in combination.

The condiment is exemplified by spicery and herbs. However, the condiment is not limited to these. It is possible to use such condiments alone or in combination. The diluent is exemplified by dextrin which is starch hydrolysate and various starches. However, the diluent is not limited to these. It is possible to use such diluents alone or in combination.

The coloring agent is exemplified by: a natural pigment (e.g., a gardenia yellow pigment, a safflower yellow pigment, or the like), a synthetic pigment (e.g., Food Yellow No. 4, Food Red No. 2, Food Blue No. 1, or the like), and a natural coloring agent (e.g., carotenoid, flavonoid, anthocyanin, or the like). However, the coloring agent is not limited to these. It is possible to use such coloring agents alone or in combination.

The amino acid and/or the derivative thereof and various additives as mentioned above each of which is contained in the salty taste enhancer according to the present invention are not particularly limited in amount, provided that the salty taste enhancer according to the present invention can enhance a salty taste of food containing sodium chloride when the food is caused to contain the salty taste enhancer according to the present invention.

For example, an amount of the amino acid and/or the derivative thereof contained in the salty taste enhancer according to the present invention is preferably 70 to 90% by weight, more preferably 80 to 99% by weight, and still more preferably 90 to 99% by weight.

When an amount of the amino acid and/or the derivative thereof contained in the salty taste enhancer according to the present invention is set in the aforementioned range, an ingredient other than the amino acid and/or the derivative thereof is small in amount. Therefore, the use of this salty taste enhancer allows prevention of a taste of food or drink from being spoiled due to an excess content of the ingredient other than the amino acid and/or the derivative thereof in the food.

An amount of potassium chloride contained in the salty taste enhancer according to the present invention is preferably 0.01 to 25% by weight, more preferably 0.01 to 15% by weight, and still more preferably 0.01 to 5% by weight, relative to a weight of a finished product.

An amount of monosodium glutaminate contained in the salty taste enhancer according to the present invention is preferably 0.01 to 5% by weight, more preferably 0.01 to 1% by weight, and still more preferably 0.01 to 1% by weight, relative to a weight of a finished product.

When amounts of potassium chloride and monosodium glutaminate contained in the salty taste enhancer according to the present invention are set in the aforementioned range, it is possible to further enhance the salty taste enhancing effect of an amino acid and/or a derivative thereof without adversely affecting a salty taste in quality.

The use of the amino acid and/or the derivative thereof thus obtained allows production of the salty taste enhancer according to the present invention. A method for the production is not particularly limited. It is possible to employ a conventionally publicly-known method. For example, the following method allows production of a solid salty taste enhancer.

In a case where the amino acid and/or the derivative thereof are/is liquid, it is possible to solidify the amino acid and/or the derivative thereof by employing a conventionally publicly-known method such as drying. Thereafter, it is possible to use the amino acid and/or the derivative thereof thus solidified as a salty state enhancer. Furthermore, it is possible to powderize a solid amino acid and/or a derivative thereof by employing a conventionally publicly-known method such as crushing. Thereafter, it is possible to use the amino acid and/or the derivative thereof thus powderized as a salty state enhancer. Moreover, it is possible to produce a tablet or a capsule salty taste enhancer by, for example, solidifying the powderized salty taste enhancer by employing a conventionally publicly-known method.

In a case where a plurality of amino acids and/or derivatives thereof are contained in a solid salty taste enhancer, it is possible to mix the amino acids and/or the derivatives thereof by employing a conventionally publicly-known method. A timing of the mixing is not particularly limited. The mixing may be carried out before or after liquid amino acids and/or derivatives thereof are dried. The mixing may also be carried out before or after solid amino acids and/or derivatives thereof are powderized. Note that a method for producing a solid salty taste enhancer is not limited to these.

Further, a method for producing a liquid salty taste enhancer is not particularly limited. It is possible to produce a liquid salty taste enhancer by, for example, dissolving an amino acid and/or a derivative thereof in a solution by employing a conventionally publicly-known method such as agitation. In this case, the amino acid and/or the derivative thereof may be liquid, solid, or in a state of a liquid-solid mixture. Furthermore, it is possible to use the solid salty taste enhancer instead of the amino acid and/or the derivative thereof. The solution is not particularly limited. For example, it is possible to use an aqueous solution such as water or an aerated water, or an oil such as a soybean oil or an olive oil.

In a case where a plurality of amino acids and/or derivatives thereof are contained in a liquid salty taste enhancer, it is possible to mix the amino acids and/or the derivatives thereof by employing a conventionally publicly-known method. A timing of the mixing is not particularly limited. The mixing may be carried out before or after the amino acids and/or the derivatives thereof are dissolved. Note that a method for producing a liquid salty taste enhancer is not limited to this.

Furthermore, it is possible to produce a solid or liquid salty taste enhancer containing an additive of various types as mentioned above by mixing the additive and an amino acid and/or a derivative thereof by employing a conventionally publicly-known method.

It is possible to enhance a salty taste of food by causing the food to contain the salty taste enhancer according to the present invention. In a case where an amount of sodium chloride contained in food is not less than 0.2% by weight, relative to the food, it is possible to enhance a salty taste of the food only by causing the food to contain the salty taste enhancer according to the present invention. In a case where of the sodium chloride content in food is less than 0.2% by weight, relative to the food, a satisfactory salty taste enhancing effect may not be obtained only by causing the food to contain the salty taste enhancer according to the present invention. However, it is possible to obtain a satisfactory salty taste enhancing effect by causing the food to contain not less than 0.2% sodium chloride by weight, relative to the food, thereafter causing the food to contain the salty taste enhancer according to the present invention.

Therefore, the use of the salty taste enhancer according to the present invention makes it possible to provide low-salt food which tastes adequately salty.

[2. Food or Drink]

<Method for Producing Food or Drink>

A method for producing food (i.e., food or drink) according to the present invention may include the step of (a) causing food to contain a salty taste enhancer containing an amino acid and/or a derivative thereof. The method may further include the step of (b) causing the food to contain sodium chloride. It is possible to appropriately employ other conventionally publicly-known steps which are employed for food or drink production. This makes it possible to avoid a cost increase in producing the food. This is because it is almost unnecessary to modify equipment to be used for producing the food or to modify steps to be employed.

It is possible to use L-leucine and/or L-isoleucine as the amino acid in the step (a). Moreover, the step (a) may cause food to contain the salty taste enhancer so that the amount of the amino acid and/or the derivative thereof contained in the food is preferably 0.2 to 0.5% by weight, more preferably 0.3 to 0.4% by weight, and still more preferably 0.35 to 0.38% by weight, relative to the food at consumption of the food. According to the range thus set, it is possible to draw a maximum salty taste enhancing effect while preventing a bitter taste due to the amino acid and/or the derivative thereof. This makes it possible to provide food which tastes adequately salty, without spoiling a taste of the food.

As described later in the Examples, in a case where the amino acid is L-leucine, it is possible to reduce an amount of sodium chloride used for food to 88% by weight by, for example, causing the food to contain a salty taste enhancer so that an amount of the L-leucine contained in the food is 0.38% by weight at consumption of the food.

The step (b) may cause food to contain sodium chloride so that the amount of sodium chloride contained in the food is not less than 0.2% by weight, relative to the food at consumption of the food. This attains a satisfactory salty taste enhancing effect. On the other hand, in a case where the amount of sodium chloride contained in the food is less than 0.2% by weight, a satisfactory salty taste enhancing effect may not be obtained even if the salty taste enhancer according to the present invention is used.

In a case where an amount of sodium chloride which is originally contained in the food is not less than 0.2% by weight, it is not always necessary to add another sodium chloride.

In a case where sodium chloride is added by the step (b), it is possible to cause food (i.e., food or drink) to contain sodium chloride so that the amount of sodium chloride contained in the food is preferably 0.2 to 10.0% by weight, more preferably 0.6 to 2.0% by weight, and still more preferably 0.8 to 1.0% by weight, relative to the food at consumption of the food, from the viewpoint of a reduction in salt of the food.

In a case where the salty taste enhancer and sodium chloride are contained in the food at the consumption of the food, it is possible to enhance a salty taste of the food though a salt content of the food is reduced. Therefore, it is possible to carry out the step (a) or the steps (a) and (b) at one or more timings selected from: (i) before the food is produced, (ii) while the food is being produced, and (iii) after the food has been produced. Note here that the steps (a) and (b) may be carried out concurrently or separately.

In a case where the step (a) is carried out before the food is produced or while the food is being produced, it is possible to carry out the step by, for example, employing a conventionally publicly-known method such as a method for: (i) mixing the salty taste enhancer into a raw material of the food and/or an unfinished product of the food, (ii) dissolving the salty taste enhancer in the raw material of the food and/or the unfinished product of the food, (iii) dispersing the salty taste enhancer over the raw material of the food and/or the unfinished product of the food, or (iv) pouring the salty taste enhancer into the raw material of the food and/or the unfinished product of the food. In a case where the step (a) is carried out after the food has been produced, it is possible to carry out the step by, for example, employing a conventionally publicly-known method such as a method for sprinkling the salty taste enhancer over a finished product of the food.

A method employed in a case where the step (b) is carried out at a timing: (i) before the food is produced, (ii) while the food is being produced, or (iii) after the food has been produced is identical to the method employed in the case (i), (ii), or (iii) of the step (a), except that sodium chloride is used instead of the salty taste enhancer.

As mentioned above, the present method for producing food allows production of food whose salty taste is enhanced since the method includes the step (a) or the steps (a) and (b). Namely, it is possible to produce low-salt food which tastes adequately salty since a salty taste is enhanced in the food produced in accordance with the method.

The present method for producing food may include the step (hereinafter referred to as the step (c)) of causing the food to contain an additive of various types as mentioned in the [1. Salty taste enhancer], in addition to the steps (a) and (b). The step (c) and the step (a) or (b) may be carried out concurrently or separately. A method employed in a case where the step (c) is carried out at a timing: (i) before the food is produced, (ii) while the food is being produced, or (iii) after the food has been produced is identical to the method employed in the case (i), (ii), or (iii) of the step (a), except that the additive as mentioned above is used in the step (c) instead of the salty taste enhancer. Furthermore, the amount of the additive contained in the food is not particularly limited provided that the amount does not spoil a taste of the food to be produced.

Note here that potassium chloride is the most preferable of various additives contained in the food in the step (c). As described earlier, the use of potassium chloride and the amino acid and/or the derivative thereof in combination allows a further enhancement of the salty taste enhancing effect of the salty taste enhancer according to the present invention. This causes the food to taste adequately salty even if a salt amount of the food is further reduced, and it is therefore possible to produce lower-salt food.

Furthermore, it is preferable for the step (c) to cause the food to further contain monosodium glutaminate in addition to potassium chloride. This allows a further enhancement of the salty taste enhancing effect of the salty taste enhancer according to the present invention than in the case where potassium chloride and the amino acid and/or the derivative thereof are used in combination.

In this case, in the step (c), an amount of potassium chloride contained in food is preferably 5 to 100% by weight, more preferably 15 to 85% by weight, and still more preferably 25 to 70% by weight, relative to the amount of sodium chloride contained in the food at the consumption of the food.

Moreover, in the step (c), an amount of monosodium glutaminate contained in the food is preferably 0.01 to 30% by weight, more preferably 0.01 to 20% by weight, and still more preferably 0.01 to 10% by weight, relative to the amount of sodium chloride contained in the food at the consumption of the food.

According to the range thus set, it is possible to attain a greater salty taste enhancing effect of the salty taste enhancer according to the present invention. This allows a further reduction in the amount of sodium chloride in the food.

For example, it is possible to reduce the sodium chloride content in the food to 80% by weight by carrying out the steps (a) and (c) so that the L-leucine content in the food is 0.38% by weight, relative to the food and the potassium chloride content is 25% by weight, relative to the amount of sodium chloride contained in the food at the consumption of the food.

<Food or Drink>

The food (i.e., food or drink) according to the present invention which can be produced by the method contains (i) a salty taste enhancer containing an amino acid and/or a derivative thereof and (ii) sodium chloride. Namely, the food according to the present invention is food containing sodium chloride and further containing the salty taste enhancer. Such food containing sodium chloride is exemplified by: (1) confectionery, (2) bakery, noodles, and rice, (3) pickles, (4) processed food in which seafood is used, (5) processed food in which meat is used, (6) seasonings, and (7) others. However, the food containing sodium chloride is not limited to these. The following specifically exemplify such food.

(1) Confectionary is exemplified by: rice crackers (senbei), cubic rice crackers (arare), millet-and-rice cakes (okoshi), rice cakes (mochi and the like), buns with bean-jam fillings (manju), sweet rice jelly (uirou), bean jams (an and the like), sweet jelly of beans (youkan), soft bean jelly (mizuyoukan), kingyoku (sugared gelatin), jelly, castella, round hard candies, biscuits, crackers, potato chips, cookies, pies, puddings, buttercream, custard, cream puffs, waffles, sponge cakes, doughnuts, chocolates, chewing gum, caramels, candies, and paste such as peanut paste. However, (1) is not limited to these.

(2) Bakery, noodles, and rice is exemplified by: bread, wheat noodles (udon), Chinese soup noodles (ramen), Chinese noodles, sushi, boiled rice cooked with solid ingredients (gomokumeshi), Chinese-style fried rice, pilafs, skins of Chinese-style dumplings such as a gyōza (jiaozi in Chinese) and shumai (shaomai in Chinese), okonomiyaki (a Japanese-style pizza), and takoyaki (octopus balls). However, (2) is not limited to these.

(3) Pickles is exemplified by: nukazuke (vegetables pickled in kasu (sake lees)), umeboshi (pickled plums), fukujinzuke (sliced vegetables pickled in soy sauce), bettarazuke (fresh radish pickles), senmaizuke (thin slices of turnip pickled in vinegar and other ingredients), rakkyo (pickled shallots), misozuke (vegetables preserved in miso), and takuan (pickled radishes). However, (3) is not limited to these.

(4) Seafood is exemplified by: fishes such as mackerel, sardine, saury, crabs, salmon, tuna, bonito, whale, flatfish, launce, and sweetfish; squid such as Todarodes pacificus, Doryteuthis bleekeri, Sepia lycidas, and Watasenia scintillans; octopuses such as Octopus vulgaris and Octopus ocellatus; prawn such as Penaeus japonicus, Pandalus nipponensis, Panulirus japonicus, and Penaeus monodon; crabs such as a king crab, a snow crab, a swimming crab, and Erimacrus isenbeckii; and shellfish such as an abalone, a clam, a scallop, an oyster, and a moule. However, (4) is not limited to these.

Processed food in which (4) is used is exemplified by: canned goods, boiled fish, tsukudani (food boiled in soy sauce), mince, fish cakes (e.g., fish sausage, steamed fish paste, fried steamed fish paste, imitation crab sticks, and the like), fries, and tempura. However, the processed food in which (4) is used is not limited to these.

(5) Meat is exemplified by: chicken, pork, beef, mutton, and horsemeat. However, (5) is not limited to these. Processed food in which (5) is used is exemplified by: curry, stew, beef stew, main ingredients of hayashi rice (rice with hashed meat), meat sauce, bean curd sauted with ground meat and chili pepper in a thick sauce (mabo doufu (mapo doufu in Chinese)), a hamburger, a gyōza (jiaozi in Chinese), an instant mix for kamameshi (rice boiled with any of a variety of ingredients in a small pot), soups, meatballs, stewed cubes of meat, and canned meat. However, the processed food in which (5) is used is not limited to these.

(6) Seasonings is exemplified by: table salt, seasoning salt, soy sauce, powdered soy sauce, miso, powdered miso, moromi (unrefined soy sauce), hishio (salted meat), furikake (rice seasonings), ochazuke (an instant mix for boiled rice soaked with tea), margarine, mayonnaise, dressing, table vinegar, a sauce of sake, soy, and vinegar, powdered sushi (sweetened) vinegar, a base for Chinese food, a thin dip for tempura, noodle dipping sauce, sauce, ketchup, sauce for grilled meat, curry roux, stew roux, soup stock, instant bouillon, and mirin (a cooking sweet sake (rice wine)). However, (6) is not limited to these.

(7) Food other than (1) through (6) is exemplified by: dairy products such as cheese and butter; vegetables; boiled food such as chikuzenni (chicken, root crops, konjak, and the like stir-fried and boiled with soy sauce and sugar), oden (a dish consisting of slices of boiled daikon, cakes of konjak, small taros, fish sausage, hard-boiled eggs, balls of processed mince fish, etc., heated in a soy sauce-based liquid), and food cooked in a pot at the table; vegetable juices; and soft drinks. However, (7) is not limited to these.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### EXAMPLES

The present invention is specifically described below with reference to the following examples.

### Example 1

### Salty Taste Enhancing Effect of L-Leucine on Sodium Chloride Solution

Sodium chloride (catalogue No. 191-01665, produced by Wako Pure Chemical Industries, Ltd.) was dissolved in water, so as to prepare an aqueous solution of 0.9% sodium chloride by weight (hereinafter referred to as a “reference aqueous solution 1”). Furthermore, sodium chloride and L-leucine (product No. L8912, produced by Sigma-Aldrich Japan K.K.) were dissolved in water, so as to prepare an aqueous solution of 0.8% sodium chloride by weight and 0.38% L-leucine by weight (hereinafter referred to as a “test aqueous solution 1”). Note, in the present specification, that test and reference aqueous solutions used for sensory evaluations were all prepared at room temperature, and the sensory evaluations were carried out at room temperature.

A sensory evaluation of the reference aqueous solution 1 and the test aqueous solution 1 was carried out with respect to 11 panels. Each of the 11 panels selected, by a paired preference test, one or the other of the two aqueous solutions whose salty taste was stronger. Similarly, each of the 11 panels selected one or the other of the two aqueous solutions whose salty taste continued longer and one or the other of the two aqueous solutions whose salty taste was fuller.

The sensory evaluation was carried out as below. Namely, each of the 11 panels was caused to take in the aqueous solutions in such a manner that: 1 ml test aqueous solution and 1 ml reference aqueous solution were alternately taken, with a dropper, from respective plastic cups containing the aqueous solutions, so that each of the 11 panels was caused to hold the aqueous solutions in their mouths. In this way, each of the 11 panels compared the two aqueous solutions. At this time, the 11 panels wore respective nose clips so as not to be influenced by smell. Note that human beings capable of distinguishing salty tastes of an aqueous solution of 0.8% sodium chloride and an aqueous solution of 0.9% sodium chloride were selected as the panels. Table 1 shows a result of a sensory test in which the reference aqueous solution 1 and the test aqueous solution 1 were used.

TABLE 1
Salty taste enhancing effect of L-leucine on sodium
chloride solution

| | | 0.8% NaCl |
|---|---|---|
| Evaluation item | 0.9% NaCl | 0.38% leucine |
| Salty taste | 2 | 9 |
| strength^{(a)} | | |
| Salty taste | 3 | 8 |
| continuity^{(b)} | | |
| Salty taste | 2 | 9 |
| fullness^{(c)} | | |

^{(a)}the number of panels who evaluated the sample was greater in salty taste strength
^{(b)}the number of panels who evaluated the sample was greater in salty state continuity
^{(c)}the number of panels who evaluated the sample was greater in salty state fullness

Table 1 shows that the test aqueous solution was superior to the reference aqueous solution in all of the items of salty taste strength, salty taste continuity, and salty taste fullness. The present example, which examined whether or not to obtain an equivalent salty taste by preparing solutions with different concentrations of sodium chloride and adding L-leucine to the solution with a lower concentration of sodium chloride, showed a tendency for the solution in which 0.38% L-leucine was added to 0.8% NaCl to be evaluated as stronger in salty taste. This has made it clear that causing an aqueous solution containing sodium chloride to contain L-leucine enhances a salty taste of the aqueous solution.

Note that L-leucine of 0.38% by weight, which is a threshold value of human beings, hardly tastes bitter whereas L-leucine alone tastes bitter. Hence, the 0.38% L-leucine by weight does not affect a salty taste in quality.

### Example 2

### Salty Taste Enhancing Effect of L-Leucine on Consommé Soup

A salt-reducing effect of L-leucine was examined by use of consommé soup as a realistic food model. Consommé soup powder offered by Kyowa Hakko Food Specialties Co., Ltd. was used for consommé soup. Table 2 shows a composition of the consommé soup powder. This powder was dissolved in water so as to have 1.6% by weight, so that consommé soup (hereinafter referred to as low-salt consommé soup) was prepared. Namely, a sodium chloride content of the low-salt consommé soup was 0.8% by weight.

TABLE 2
Composition of consomme soup powder

| Raw materials | Compositions (g) |
|---|---|
| Sodium chloride | 50.0 |
| White superior soft sugar | 7.0 |
| Celery powder | 0.2 |
| White pepper | 0.2 |
| Caramel | 1.2 |
| Lactose | 33.9 |
| Onion essence P | 3.0 |
| Beef No65 | 3.0 |
| Glu essence | 1.5 |
| Total | 100.0 |

A reference consommé soup was prepared by causing the low-salt consommé soup to contain 0.1% sodium chloride by weight, relative to an amount of the soup. Namely, a sodium chloride content of the reference consommé soup was 0.9% by weight.

A sensory evaluation of the low-salt consommé soup and the reference consommé soup was carried out with respect to 11 panels by the paired preference test. Each of the 11 panels selected one or the other of the two soups whose salty taste was stronger. Table 3 shows a result of the sensory evaluation.

TABLE 3

| | | 1.6% consommé |
|---|---|---|
| | 1.6% consommé | 0.1% NaCl |
| Salty taste | 1 | 10 |
| strength^{(a)} | | |

^{(a)}the number of panels who evaluated the sample was greater in salty taste

Table 3 shows that each of the 11 panels was able to significantly evaluate a difference of 0.1% in concentration of sodium chloride between the consommé soups (p<0.05).

Furthermore, a test consommé soup was prepared by causing the low-salt consommé soup to contain 0.38% L-leucine by weight, relative to an amount of the soup.

A sensory evaluation of the reference consommé soup and the test consommé soup was carried out with respect to the 11 panels by the paired preference test. Each of the 11 panels selected one or the other of the soups whose salty taste was stronger. Table 4 shows a result of the sensory evaluation.

TABLE 4

| | 1.6% consommé | 1.6% consommé |
|---|---|---|
| | 0.38% leucine | 0.1% NaCl |
| Salty taste | 5 | 6 |
| strength^{(a)} | | |
| Bitter taste | 6 | 5 |
| strength^{(b)} | | |

^{(a)}the number of panels who evaluated the sample was greater in salty taste
^{(b)}the number of panels who evaluated the sample was greater in bitter taste

Table 4 shows that there was little difference in salty taste strength between the test consommé soup and the reference consommé soup. Table 4 also shows that there was little difference in bitter taste strength between the test consommé soup and the reference consommé soup. This has made it clear that the use of sodium chloride and L-leucine in combination allows an enhancement of the salty taste of the low-salt consommé soup without affecting the taste of the low-salt consommé soup in quality.

It has also been made clear that the use of sodium chloride and L-leucine in combination allows an achievement of an about 12% reduction in salt content. This is because there is little difference in salty taste strength between the reference consommé soup and the test consommé soup though the sodium chloride content of the reference consommé soup was 0.9% by weight and the sodium chloride content of the test consommé soup was 0.8% by weight.

According to this, it can be said that it is possible to provide low-salt food which tastes adequately salty by causing the low-salt food to contain L-leucine.

### Example 3

### Salty Taste Enhancing Effects of L-Leucine And Potassium Chloride on Sodium Chloride Solution

Sodium chloride and L-leucine which were used in Example 1 and potassium chloride (model No. P9333, produced by Sigma-Aldrich) were dissolved in water, so as to prepare an aqueous solution of 0.8% sodium chloride by weight, 0.38% L-leucine by weight, and 0.2% potassium chloride by weight (hereinafter referred to as a “test aqueous solution 2”).

Moreover, the sodium chloride was dissolved in water, so as to prepare an aqueous solution of 1.0% sodium chloride by weight (hereinafter referred to as a “reference aqueous solution 2”).

A sensory evaluation of the reference aqueous solution 2 and the test aqueous solution 2 was carried out with respect to 11 panels by the paired preference test. Each of the 11 panels selected one or the other of the two aqueous solutions whose salty taste was stronger. Table 5 shows a result of the sensory evaluation.

TABLE 5

| | | 0.8% NaCl |
|---|---|---|
| | | 0.2% KCl |
| | 1.0% NaCl | 0.38% leucine |
| Salty taste | 6 | 4 |
| strength^{(a)} | | |

^{(a)}the number of panels who evaluated the sample was greater in salty taste

Table 5 shows that the test aqueous solution 2 and the reference aqueous solution 2 were substantially equivalent in salty taste strength. This has made it clear that the use of sodium chloride, L-leucine, and potassium chloride in combination allows an achievement of a 20% reduction in salt while keeping salty taste strength.

### Example 4

### Salty Taste Enhancing Effects of L-Leucine, Potassium Chloride, and Monosodium Glutaminate on Sodium Chloride Solution

The sodium chloride, L-leucine and potassium chloride which were used in Example 3 and monosodium glutaminate (model No. 282800, produced by Sigma-Aldrich) were dissolved in water, so as to prepare an aqueous solution of 0.7% sodium chloride by weight, 0.38% L-leucine by weight, 0.2% potassium chloride by weight, and 0.04% monosodium glutaminate by weight (hereinafter referred to as a “test aqueous solution 3”).

A sensory evaluation was carried out with respect to 11 panels by use of an aqueous solution of 1.0% sodium chloride by weight and 0.04% monosodium glutaminate by weight as a reference aqueous solution. The sensory evaluation was carried out by the paired preference test, and each of the 11 panels selected one or the other of the two aqueous solutions whose salty taste was stronger. Table 6 shows a result of the sensory evaluation.

TABLE 6

| | | 0.7% NaCl |
|---|---|---|
| | | 0.04% MSG |
| | 1.0% NaCl | 0.38% leucine |
| | 0.04% MSG | 0.2% KCl |
| Salty taste | 7 | 7 |
| strength^{(a)} | | |

^{(a)}the number of panels who evaluated the sample was greater in salty taste

Table 6 shows that the test aqueous solution 3 and the reference aqueous solution are substantially equivalent in salty taste strength. This has made it clear that the use of sodium chloride, L-leucine, potassium chloride, and monosodium glutaminate in combination allows an achievement of a 30% reduction in salt while keeping salty taste strength.

### Example 4

### Salty Taste Enhancing Effect of L-Isoleucine on Sodium Chloride Solution

The sodium chloride which was used in Example 1 was dissolved in water, so as to prepare an aqueous solution of 0.8% sodium chloride by weight (hereinafter referred to as a “reference aqueous solution 3”). Furthermore, the sodium chloride and L-isoleucine (model No. 17403, produced by Sigma-Aldrich) were dissolved in water, so as to prepare an aqueous solution of 0.8% sodium chloride by weight and 0.55% L-isoleucine by weight (hereinafter referred to as a “test aqueous solution 4”).

A sensory evaluation of the reference aqueous solution 3 and the test aqueous solution 4 was carried out with respect to 11 panels by the paired preference test. Each of the 11 panels selected one or the other of the two aqueous solutions whose salty taste was stronger. Table 7 shows a result of the sensory evaluation.

TABLE 7

| | | 0.8% NaCl |
|---|---|---|
| | 0.8% NaCl | 0.55% isoleucine |
| Salty taste | 2 | 9 |
| strength^{(a)} | | |

^{(a)}the number of panels who evaluated the sample was greater in salty taste

Table 7 shows a tendency for a salty taste to be enhanced by addition of L-isoleucine, and it has been made clear that causing an aqueous solution containing sodium chloride to contain L-isoleucine allows an enhancement of a salty taste of the aqueous solution.

### Comparative Example 1

### Salty Taste Enhancing Effect Obtained in a Case where L-Valine is Used

The sodium chloride which was used in Example 1 and L-valine (model No. C0750, produced by Sigma-Aldrich) were dissolved in water, so as to prepare an aqueous solution of 0.8% sodium chloride by weight and 0.65% L-valine by weight (hereinafter referred to as a “test aqueous solution 5”).

A sensory evaluation of the reference aqueous solution 3 and the test aqueous solution 5 was carried out with respect to 11 panels by the paired preference test. Each of the panels selected one or the other of the two aqueous solutions whose salty taste was stronger. Table 8 shows a result of the sensory evaluation.

TABLE 8

| | | 0.8% NaCl |
|---|---|---|
| | 0.8% NaCl | 0.65% valine |
| Salty taste | 9 | 2 |
| strength^{(a)} | | |

^{(a)}the number of panels who evaluated the sample was greater in salty taste

Table 8 shows a tendency for a salty taste to be weakened by addition of L-isoleucine.

Next, the sodium chloride which was used in Example 1 and L-valine (model No. V0513, produced by Sigma-Aldrich) were dissolved in water, so as to prepare an aqueous solution of 0.9% sodium chloride by weight and 0.65% L-valine by weight (hereinafter referred to as a “test aqueous solution 6”).

A sensory evaluation of the reference aqueous solution 1 and the test aqueous solution 6 was carried out with respect to 11 panels by the paired preference test. Each of the panels selected one or the other of the two aqueous solutions whose salty taste was stronger. Table 9 shows a result of the sensory evaluation.

TABLE 9

| | | 0.9% NaCl |
|---|---|---|
| | 0.9% NaCl | 0.65% valine |
| Salty taste | 10 | 1 |
| strength^{(a)} | | |

^{(a)}the number of panels who evaluated the sample was greater in salty taste

Table 9 shows that a salty taste of the reference aqueous solution 1 was significantly weakened by addition of L-valine (p<0.05). This has made it clear that the use of L-valine as an amino acid does not allow an obtainment of the effect of the present invention.

### Comparative Example 2

### Salty Taste Enhancing Effect Obtained in a Case where Caffeine is Used

The sodium chloride which was used in Example 1 and caffeine (model No. C0750, produced by Sigma-Aldrich) were dissolved in water, so as to prepare an aqueous solution of 0.8% sodium chloride by weight and 0.02% caffeine by weight (hereinafter referred to as a “test aqueous solution 7”).

A sensory evaluation of the reference aqueous solution 3 and the test aqueous solution 7 was carried out with respect to 11 panels by the paired preference test. Each of the panels selected one or the other of the two aqueous solutions whose salty taste was stronger. Table 10 shows a result of the sensory evaluation.

TABLE 10

| | | 0.8% NaCl |
|---|---|---|
| | 0.8% NaCl | 0.02% caffeine |
| Salty taste | 7 | 4 |
| strength^{(a)} | | |

^{(a)}the number of panels who evaluated the sample was greater in salty taste

Further, sodium chloride which was used in Example 1 and the caffeine were dissolved in water, so as to prepare an aqueous solution of 0.9% sodium chloride by weight and 0.02% caffeine by weight (hereinafter referred to as a “test aqueous solution 8”).

A sensory evaluation of the reference aqueous solution 1 (aqueous solution of 0.9% sodium chloride by weight) and the test aqueous solution 8 was carried out with respect to 11 panels by the paired preference test. Each of the panels selected one or the other of the two aqueous solutions whose salty taste was stronger. Table 11 shows a result of the sensory evaluation.

TABLE 11

| | | 0.9% NaCl |
|---|---|---|
| | 0.9% NaCl | 0.02% caffeine |
| Salty taste | 6 | 5 |
| strength^{(a)} | | |

^{(a)}the number of panels who evaluated the sample was greater in salty taste

Tables 10 and 11 show that neither the 0.8% sodium chloride solution by weight nor the 0.9% sodium chloride solution by weight saw any enhancement of a salty taste by addition of caffeine.

### Comparative Example 3

### Salty Taste Enhancing Effect Obtained in a Case where Quinine Hydrochloride is Used

Sodium chloride which was used in Example 1 and quinine hydrochloride (produced by Wako Pure Chemical Industries, Ltd.) were dissolved in water, so as to prepare an aqueous solution of 0.8% sodium chloride by weight and 0.002% quinine hydrochloride by weight (hereinafter referred to as a “test aqueous solution 9”).

A sensory evaluation of the reference aqueous solution 3 (0.8% sodium chloride solution by weight) and the test aqueous solution 9 was carried out with respect to 11 panels by the paired preference test. Each of the panels selected one or the other of the two aqueous solutions whose salty taste was stronger. Table 12 shows a result of the sensory evaluation.

TABLE 12

| | | 0.8% NaCl |
|---|---|---|
| | | 0.002% quinine |
| | 0.8% NaCl | hydrochloride |
| Salty taste | 7 | 4 |
| strength^{(a)} | | |

^{(a)}the number of panels who evaluated the sample was greater in salty taste

Table 12 shows that the addition of quinine hydrochloride allowed no enhancement of a salty taste.

### Comparative Example 4

### Salty Taste Enhancing Effect Obtained in a Case where Arginyl-Leucine is Used

Sodium chloride which was used in Example 1 and arginyl-leucine (produced by Sigma-Aldrich) were dissolved in water, so as to prepare an aqueous solution of 0.8% sodium chloride by weight and 0.2% arginyl-leucine by weight (hereinafter referred to as a “test aqueous solution 10”).

A sensory evaluation of the reference aqueous solution 3 and the test aqueous solution 10 was carried out with respect to 11 panels by the paired preference test. Each of the panels selected one or the other of the two aqueous solutions whose salty taste was stronger. Table 13 shows a result of the sensory evaluation.

TABLE 13

| | | 0.8% NaCl |
|---|---|---|
| | 0.8% NaCl | 0.2% Arg-Leu |
| Salty taste | 7 | 4 |
| strength^{(a)} | | |

^{(a)}the number of panels who evaluated the sample was greater in salty taste

Table 13 shows that the addition of arginyl-leucine which is a dipeptide allowed no enhancement of a salty taste.

As described earlier, a salty taste enhancer according to the present invention contains an amino acid and/or a derivative thereof, the amino acid being L-leucine and/or L-isoleucine. This brings about an effect that it is possible to effectively enhance a salty taste of food by causing the food to contain the salty taste enhancer according to the present invention, which contains the foregoing chemical compound(s).

Furthermore, the salty taste enhancer according to the present invention brings about an effect of an enhancement of a salty taste of the food, and it is therefore possible to cause the food to taste adequately salty even if a salt content of the food is reduced. Namely, the salty taste enhancer according to the present invention allows a reduction in a salt content of the food while keeping the food adequately salty. An increased intake of sodium chloride increases the risk of a lifestyle-related illness such as high blood pressure. Therefore, even a small reduction in the intake is highly effective for health maintenance. Accordingly, it is possible to utilize the salty taste enhancer according to the present invention for health maintenance such as the prevention of a lifestyle-related illness.

Moreover, the foregoing leucine and isoleucine are branched-chain amino acids which have functions such as a performance-enhancing function, and are actually used for supplements and beverages. This brings about an effect that it is possible to provide, by use of the amino acid, a salty taste enhancer which is harmless to human.

Furthermore, a method for producing food according to the present invention, includes the steps of: (i) causing the food to contain a salty taste enhancer containing an amino acid and/or a derivative thereof and (ii) causing the food to contain sodium chloride, the amino acid being L-leucine and/or L-isoleucine. This allows production of food (i.e., food or drink) whose salty taste is enhanced. Namely, a salty taste of food produced in accordance with the method is enhanced, and it is therefore possible to reduce a salt amount of the food. This allows production of low-salt food which tastes adequately salty.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

A salty taste enhancer according to the present invention allows an enhancement of a salty taste of food (i.e., food or drink). Therefore, even if a salt content of food is reduced, it is possible to cause the food to have an equivalent taste or a saltier taste as compared with food in which salt is not reduced. Accordingly, by use of the salty taste enhancer, it is possible to provide an adequately salty low-salt food and a method for producing the low-salt food. This allows an employment of the present invention for a food manufacturing industry.

1. A salty taste enhancer comprising at least one of an amino acid and a derivative of the amino acid, the amino acid being L-leucine, or L-leucine and L-isoleucine.

2. The salty taste enhancer as set forth in claim 1, further comprising potassium chloride.

3. The salty taste enhancer as set forth in claim 2, further comprising monosodium glutaminate.

4.-8. (canceled)

9. Food comprising a salty taste enhancer as set forth in claim 1,
the food containing 0.2 to 0.5% by weight of at least one of an amino acid and a derivative of the amino acid, relative to the food,
the amino acid being L-leucine, or L-leucine and L-isoleucine.

10. A method for producing food, comprising the step of causing the food to contain a salty taste enhancer as set forth in claim 1,
the step causing the food to contain the salty taste enhancer such that the food contains 0.2 to 0.5% by weight of at least one of an amino acid and a derivative of the amino acid, relative to the food,
the amino acid being L-leucine, or L-leucine and L-isoleucine.
